(19) United States
(12) Patent Application Publication
(10) Pub. No.: US 2024/0269516 A1
(43) Pub. Date: Aug. 15, 2024

(54) CONNECTED FITNESS GAMING PLATFORM

(71) Applicant: PELOTON INTERACTIVE, INC., New York, NY (US)

(72) Inventors: David PACKLES, New York, NY (US); Bud INTONATO, Brooklyn, NY (US); Benoit DION, New York, NY (US)

(21) Appl. No.: 18/566,381

(22) PCT Filed: Jun. 3, 2022
(86) PCT No.: PCT/US2022/032158

§ 371 Date: Dec. 1, 2023

Related U.S. Application Data
(60) Provisional application No. 63/196,445, filed on Jun. 3, 2021.
(60) Provisional application No. 63/309,321, filed on Feb. 11, 2022.

(51) Int. Cl. A63B 24/00; A63B 71/06

(52) U.S. Cl. CPC A63B 24/0087; A63B 24/0006; A63B 24/0062; A63B 71/0622; A63B 71/0669; A63B 2024/0096; A63B 2071/0625

(57) ABSTRACT

Various systems and methods that enhance an exercise activity performed by a user are described. In some embodiments, the systems and methods include a gaming platform that presents video games, virtual games, and other digital or interactive experiences to players that are working out or performing an exercise activity. The platform can facilitate the control of game actions within a game based on what the user does or performs during the exercise activity, such as when the user adjusts a difficulty level of the exercise activity.

### CROSS REFERENCE TO RELATED APPLICATIONS

This application claims priority to U.S. Provisional Patent Application No. 63/196,445, filed on Jun. 3, 2021, entitled CONNECTED FITNESS GAMING PLATFORM, and U.S. Provisional Patent Application No. 63/309,321, filed on Feb. 11, 2022, entitled CONNECTED FITNESS GAMING PLATFORM, both of which are hereby incorporated by reference in their entirety.

### BACKGROUND

The world of connected fitness is an ever-expanding one. This world can include a user taking part in an activity (e.g., running, cycling, lifting weights, and so on), other users also performing the activity, and many other users doing other activities. The users may be exercising on a fitness machine (e.g., a treadmill, a stationary bike, a strength machine, a stationary rower, and so on), or may be moving through the world on a bicycle, boat, skiing, or other exercise equipment.

The users can also be performing activities that do not include an associated machine or other equipment, such as running, strength training, yoga, stretching, hiking, climbing, and so on. These users can have a wearable device or mobile device that monitors the activity and may perform the activity in front of a user interface (e.g., a display or device) presenting content associated with the activity.

The user interface, whether a mobile device, a display device, or a display that is part of a machine, can provide or present interactive content to the users. For example, the user interface can present live or recorded classes, video tutorials of activities, leaderboards and other competitive or interactive features, progress indicators (e.g., via time, distance, and other metrics), virtual games or interactive experiences, augmented or mixed reality scenarios, and so on.

For example, the interactive content can include video or images that mimic or simulate the user traveling or moving (e.g., running, biking, rowing, and so on) through a virtual environment, such as a virtual game or other digitally rendered interactive environment.

### BRIEF DESCRIPTION OF THE DRAWINGS

Embodiments of the present technology will be described and explained through the use of the accompanying drawings.

FIG. 1 is a block diagram illustrating a suitable network environment for users of a gaming platform.

FIG. 2 is a block diagram illustrating components of a gaming platform or system.

FIG. 3 is a flow diagram illustrating a method for performing a game action within a video game associated with an exercise machine.

FIG. 4 is a flow diagram illustrating a method for controlling a video game via an exercise bicycle.

FIGS. 5A-5E are diagrams illustrating the control of an avatar within a video game using an exercise machine.

FIGS. 6A-6B are diagrams illustrating an example pickup game mechanic provided by a video game associated with an exercise machine.

FIGS. 7A-8B are diagrams illustrating an example breaker game mechanic provided by a video game associated with an exercise machine.

FIGS. 8A-8B is a diagram illustrating an example stream game mechanic provided by a video game associated with an exercise machine.

FIG. 9 is a diagram illustrating an example cadence game mechanic provided by a video game associated with an exercise machine.

FIG. 10 is a diagram illustrating an example player guidance game mechanic provided by a video game associated with an exercise machine.

FIG. 11 is a diagram illustrating an example user interface that facilitates the selection of a difficulty level for a video game associated with an exercise machine.

FIG. 12 is a diagram illustrating an example user interface that presents game accomplishment information for a video game associated with an exercise machine.

FIG. 13 is a diagram illustrating an example user interface that presents a leaderboard for a video game associated with an exercise machine.

FIG. 14 is a diagram illustrating an example user interface that presents user-selectable games to be played with an exercise machine.

In the drawings, some components are not drawn to scale, and some components and/or operations can be separated into different blocks or combined into a single block for discussion of some of the implementations of the present technology. Moreover, while the technology is amenable to various modifications and alternative forms, specific implementations have been shown by way of example in the drawings and are described in detail below. The intention, however, is not to limit the technology to the particular implementations described. On the contrary, the technology is intended to cover all modifications, equivalents, and alternatives falling within the scope of the technology as defined by the appended claims.

### DETAILED DESCRIPTION

### Overview

Various systems and methods that enhance an exercise activity performed by a user are described. In some embodiments, the systems and methods include a gaming platform that presents video games, virtual games, and other digital or interactive experiences to players that are working out or performing an exercise activity. The platform can facilitate the control of game actions within a game based on what the user does or performs during the exercise activity.

For example, an exercise machine or device, such as a treadmill, exercise bicycle, rower, strength machine, and so on, can act as a multi-input controller for a game, where the controller is constantly providing an ever-changing effort or activity level to the gaming platform, which performs game actions within a game in response to the effort or activity level.

Thus, a video game, via the gaming platform, can utilize various inputs when controlling avatars and actions within the game, such as incline or speed metrics received from treadmills, cadence, resistance, or pedal metrics from bicycles, tamper, stroke rate, form, or stroke output metrics from rowing machines, biometric information or metrics (e.g., heart rate), computer vision determined metrics (e.g., form, exercise counting or reps), and/or other information received from auxiliary controllers or other controllers or devices.

For example, the gaming platform can perform a method of receiving an indication that a user of an exercise machine has adjusted a difficulty setting of the exercise machine, and cause an avatar associated with the user that is within an interactive game displayed to the user via a display of the exercise machine to move within the interactive game based on the adjustment of the difficulty setting of the exercise machine.

In some cases, the exercise machine is an exercise bicycle, and the gaming platform causes the avatar to move within the interactive game when the user adjusts a resistance setting of the exercise bicycle via a resistance knob of the exercise bicycle. In other cases, the exercise machine is a treadmill, and the gaming platform causes the avatar to move within the interactive game when the user adjusts an incline level of the treadmill via a rotary control of the treadmill.

Thus, an interactive game can control, move, or otherwise perform actions for the avatar based on a current or changing cadence (e.g., how fast a flywheel of the exercise bicycle is spinning based on user pedaling), a current or changing resistance (e.g., a resistance applied to the spinning of the flywheel that is adjusted by the user upon rotating a mechanical knob of the bicycle), a change in incline or speed of a treadmill (e.g., via a rotary control or user interface control), a current or changing power or output level (e.g., metrics derived from combinations of resistance and cadence), and so on.

Various embodiments of the systems and methods will now be described. The following description provides specific details for a thorough understanding and an enabling description of these embodiments. One skilled in the art will understand, however, that these embodiments may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments.

### Examples of a Suitable Gaming Platform

The technology described herein is directed, in some embodiments, to providing a user with an enhanced user experience when performing an exercise activity, such as an exercise activity as part of a connected fitness system or other exercise system. As described herein, the exercise activity can be part of a gaming platform, such as a platform that provides a virtual game, video game, interactive game, or other interactive experience that presents gaming content and actions based on and in response to the exercise activity being performed by the user.

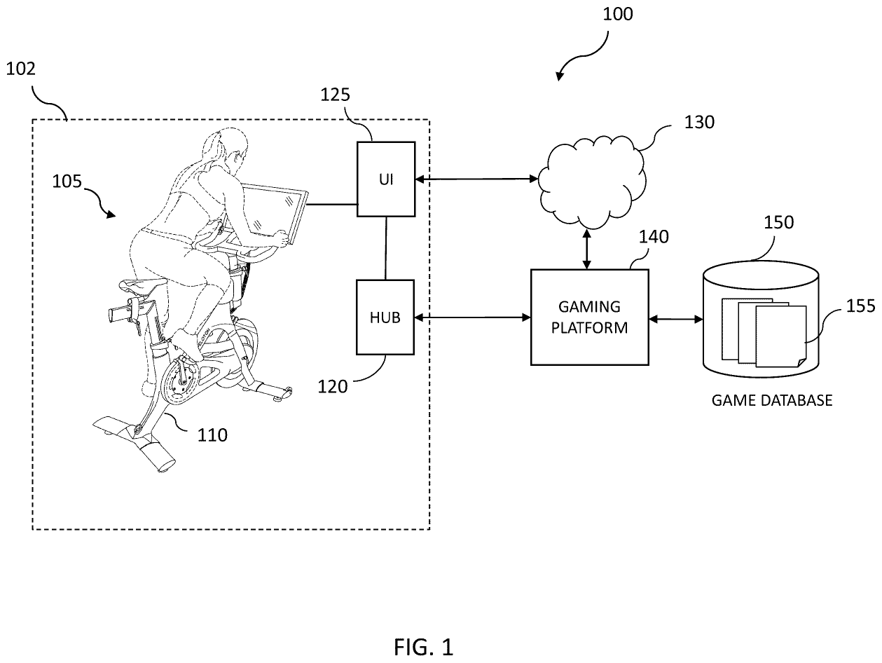

FIG. 1 is a block diagram illustrating a suitable network environment 100 for users or players of a gaming platform 150. In some embodiments, the gaming platform 150 provides various digital games and other digital or virtual experiences to users or members of a connected fitness system or service.

The network environment 100 includes an activity environment 102, where a user 105 is performing an exercise activity, such as a cycling activity. In some cases, the user 105 can perform the activity with an exercise machine 110, such as cycling with an exercise bicycle. The exercise activity performed by the user 105 can include a variety of different workouts, activities, actions, and/or movements, such as movements associated with stretching, doing yoga, lifting weights, rowing, running, cycling, jumping, sports movements (e.g., throwing a ball, pitching a ball, hitting, swinging a racket, swinging a golf club, kicking a ball, hitting a puck), and so on.

The exercise machine 110 can assist or facilitate the user 105 to perform the movements and/or can present interactive content, such as a digital game, to the user 105 when the user 105 performs the activity. For example, the exercise machine 110 can be a stationary bicycle, a stationary rower, a treadmill, a weight machine, or other machines. As another example, the exercise machine 110 can include a display device that presents content (e.g., classes, dynamically changing video, audio, video games, instructional content, and so on) to the user 105 during an activity or workout.

The exercise machine 110, in some cases, includes or is associated with a media hub 120 and a user interface 125. The media hub 120, in some cases, captures images and/or video of the user 105, such as images of the user 105 performing different movements, or poses, during an activity. The media hub 120 can include a camera or cameras, a camera sensor or sensors, or other optical sensors configured to capture the images or video of the user 105.

In some cases, the media hub 120 includes components configured to present or display information to the user 105. For example, the media hub 120 can be part of a set-top box or other similar device that outputs signals to a display, such as the user interface 125. Thus, the media hub 120 can operate to both capture images of the user 105 during an activity, while also presenting content (e.g., gaming content) to the user 105 during the activity.

The user interface 125 provides the user 105 with an interactive experience, such as a digital video game or interactive game, during the activity. For example, the user interface 125 can present a gaming environment that renders digital content in response to user actions with the exercise machine 110, such as when the user changes speeds, changes effort levels, changes output levels, changes resistance levels (e.g., for an exercise bicycle or rower), changes incline levels (e.g., for a treadmill), modifies their exercise actions (e.g., stands up, hops, or jumps on an exercise bicycle), and so on.

The exercise machine 110, the media hub 120, and/or the user interface 125 can send or receive information over a network 130, such as a wireless network. Thus, in some cases, the user interface 125 is a display device (e.g., attached to the exercise machine 110), that receives content from (and sends information, such as user selections) a gaming platform 140 over the network 130. In other cases, the media hub 120 controls the communication of content to/from the gaming platform 140 over the network 130 and presents the gaming content to the user via the user interface 125.

The gaming platform 140, located at one or more servers remote from the user 105 (e.g., cloud-based servers), can access content via a gaming content database 150, which stores gaming content 155 (images, graphics, music, and so on) to be presented during and/or within a video game.

The gaming platform 140 can present a variety of different video games or digital experiences to the user 105 when the user is performing an exercise activity. For example, the platform 140 can present competition games, abstract games, strategy games, progression games, music rhythm games, and so on. Further details regarding the types of video games or other digital experiences supported by the gaming platform 140 are described herein.

FIG. 1 and the components, systems, servers, and devices depicted herein provide a general computing environment and network within which the technology described herein can be implemented. Further, the systems, methods, and techniques introduced here can be implemented as special-purpose hardware (for example, circuitry), as programmable circuitry appropriately programmed with software and/or firmware, or as a combination of special-purpose and programmable circuitry. Hence, implementations can include a machine-readable medium having stored thereon instructions which can be used to program a computer (or other electronic devices) to perform a process. The machine-readable medium can include, but is not limited to, floppy diskettes, optical discs, compact disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other types of media/machine-readable medium suitable for storing electronic instructions.

The network or cloud 130 can be any network, ranging from a wired or wireless local area network (LAN), to a wired or wireless wide area network (WAN), to the Internet or some other public or private network, to a cellular (e.g., 4G, LTE, or 5G network), and so on. While the connections between the various devices and the network 130 and are shown as separate connections, these connections can be any kind of local, wide area, wired, or wireless network, public or private.

Further, any or all components depicted in the Figures described herein can be supported and/or implemented via one or more computing systems, servers, or cloud-based systems. Although not required, aspects of the various components or systems are described in the general context of computer-executable instructions, such as routines executed by a general-purpose computer, e.g., mobile device, a server computer, or personal computer. The system can be practiced with other communications, data processing, or computer system configurations, including: Internet appliances, hand-held devices, wearable devices, or mobile devices (e.g., smart phones, tablets, laptops, smart watches), all manner of cellular or mobile phones, multi-processor systems, microprocessor-based or programmable consumer electronics, set-top boxes, network PCs, mini-computers, mainframe computers, AR/VR devices, gaming devices, and the like. Indeed, the terms “computer,” “host,” and “host computer,” and “mobile device” and “handset” are generally used interchangeably herein and refer to any of the above devices and systems, as well as any data processor.

Aspects of the system can be embodied in a special purpose computing device or data processor that is specifically programmed, configured, or constructed to perform one or more of the computer-executable instructions explained in detail herein. Aspects of the system may also be practiced in distributed computing environments where tasks or modules are performed by remote processing devices, which are linked through a communications network, such as a Local Area Network (LAN), Wide Area Network (WAN), or the Internet. In a distributed computing environment, program modules may be located in both local and remote memory storage devices.

Aspects of the system may be stored or distributed on computer-readable media (e.g., physical and/or tangible non-transitory computer-readable storage media), including magnetically or optically readable computer discs, hard-wired or preprogrammed chips (e.g., EEPROM semiconductor chips), nanotechnology memory, or other data storage media. Indeed, computer implemented instructions, data structures, screen displays, and other data under aspects of the system may be distributed over the Internet or over other networks (including wireless networks), or they may be provided on any analog or digital network (packet switched, circuit switched, or other scheme). Portions of the system may reside on a server computer, while corresponding portions may reside on a client computer such as an exercise machine, display device, or mobile or portable device, and thus, while certain hardware platforms are described herein, aspects of the system are equally applicable to nodes on a network. In some cases, the mobile device or portable device may represent the server portion, while the server may represent the client portion.

### Examples of an Exercise-Based Video Game

As described herein, in some embodiments, the systems and methods present video games to users within a connected fitness platform, such as users performing exercise activities on treadmills, exercise bikes, rowing machines, and/or other exercise machines that facilitate the performance of real-world exercise activities (e.g., running, cycling, rowing, and so on). The video games can include various types of video games, including single-player games, progression games, music games or music-rhythm games, and so on.

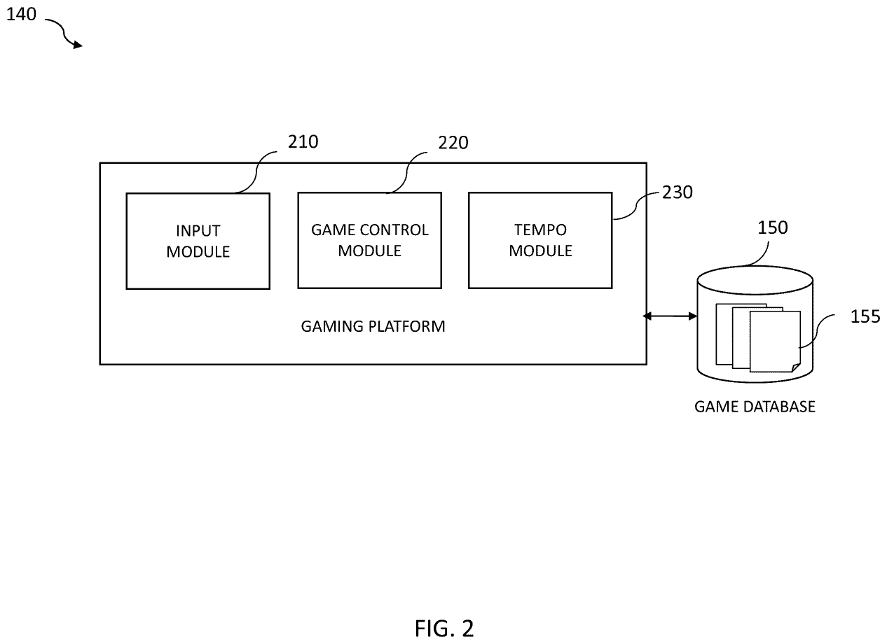

FIG. 2 illustrates the various components or modules of the gaming platform 140. The gaming platform 140, which can be a system of components, modules, or devices, functions to present gaming content to users (e.g., players) of exercise machines, such as members of a connected fitness platform or service. The components and/or modules of the gaming platform 140 can be implemented with a combination of software (e.g., executable instructions, or computer code) and hardware (e.g., at least a memory and processor). Accordingly, as used herein, in some embodiments, a component/module is a processor-implemented component/module and represents a computing device having a processor that is at least temporarily configured and/or programmed by executable instructions stored in memory to perform one or more of the functions that are described herein. The gaming platform 140 includes an input module 210, a game control module 220, and a tempo module 230.

In some embodiments, the input module 210 is configured and/or programmed to interface with an exercise machine upon which a user is performing an exercise activity. For example, the input module 210 can receive input from the exercise machine 110, such as input information that represents an effort of the user while the user is performing the exercise activity and input information that indicates a current setting of the exercise machine while the user is performing the exercise activity.

In cases where the exercise machine 110 is an exercise bicycle, the input module 210 can receive cadence or pedaling information from the bicycle as the information that represents the effort of the user during the activity, and can receive resistance level information (e.g., a current or modified resistance or brake setting for the bicycle) as the information that represents the current setting of the exercise machine.

In cases where the exercise machine 110 is a treadmill, the input module 210 can receive speed information (e.g., treadmill belt speed) from the treadmill as the information that represents the effort of the user during the activity, and can receive incline level information (e.g., a current or modified incline of the treadmill deck) as the information that represents the current setting of the exercise machine.

The input module 210 can receives or otherwise access other information from the exercise machine 110 and/or the user of the machine 110. For example, the exercise bicycle can include pedal sensors, crank arm sensors, seat sensors, and so on, which can capture information indicating the user is standing, hopping, leaning, or otherwise in certain positions on the bicycle. The input module 210 can receive or access such information as information indicating the user is moving on the bicycle in a certain position or motion (e.g., standing up, standing on one pedal, and so on).

In some embodiments, the game control module 220 is configured and/or programmed to communicate with the input module 210 and control a video game running within a video game environment that is presented to the user performing the exercise activity via a display of the exercise machine. The game control module 220 can cause an avatar that represents the user performing the exercise activity to move within the video game to a location within the video game that is associated with the current setting of the exercise machine and/or cause the user performing the exercise activity to score points within the video game when the information that represents the effort of the user satisfies a threshold associated with points rewards within the video game running within the video game environment.

In some cases, the game control module 220 causes the user performing the exercise activity to score points within the video game when the information that represents the effort of the user indicates the user has increased an effort of performing the exercise activity for a certain period of time. For example, the user can increase their cadence of pedaling for 20 seconds at a certain game scoring object and score additional points in response to the increase in the cadence.

In some cases, the game control module 220 causes the user performing the exercise activity to score points within the video game when the information that represents the effort of the user indicates the user has maintained a threshold effort of performing the exercise activity for a certain time period. For example, the user can maintain a certain cadence level for a minimum amount of time or when moving through a certain visual area of the game (e.g., within a lane) and continuously score points as they travel through the area of the game.

In some embodiments, the tempo module 230 is configured and/or programmed to present music at a certain tempo and cause the user (via an avatar that represents the user) to travel, move, or progress through the video game at the certain tempo of the presented music. For example, the tempo module 230, via the video game, causes the avatar that represents the user performing the exercise activity to progress through the video game at a speed that matches a tempo of music being played within the video game and/or to encounter scoring objects within the video game at a speed that matches a tempo of music being played within the video game.

Thus, in some embodiments, the gaming platform 140 can control the movement of an avatar representing a user based on changes made to exercise machine difficulty settings (e.g., resistance or incline levels), can control the scoring of points or rewards based on effort metrics associated with the user performing the exercise activity (e.g., cadence or speed), and/or can control the progression through the video game based on a tempo of music playing during the video game.

The following implementations illustrate how the gaming platform 140 can control actions within a video game environment:
When the exercise machine is an exercise bicycle and the current setting of the exercise bicycle is a resistance setting set by the user of the exercise bicycle by turning a resistance knob of the exercise bicycle, the game control module 220 causes the avatar that represents the user performing the exercise activity to move from a first location within the video game to a second location within the video game when the input module 210 receives information that the user has turned the resistance knob to increase the resistance setting of the exercise bicycle;
When the exercise machine is a treadmill and the current setting of the treadmill is an incline level setting set by the user of the treadmill by turning a rotary control of the treadmill, the game control module 220 causes the avatar that represents the user performing the exercise activity to move from a first location within the video game to a second location within the video game when the input module 210 receives information that the user has turned the rotary control to increase the incline level setting of the treadmill;
and other implementations (e.g., on a rower, elliptical machine, stair machine, adaptive motion trainer (AMT), and so on).

As described herein, the gaming platform 140 can utilize various game mechanics when rendering, presenting, and/or displaying gaming or interactive content, such as avatars, actions, graphics, and so on. For example, the gaming platform 140 ties or causes game actions (e.g., movement of an avatar within a game) to respond to specific actions or activities performed by a user with their exercise machine, such as machine 110.

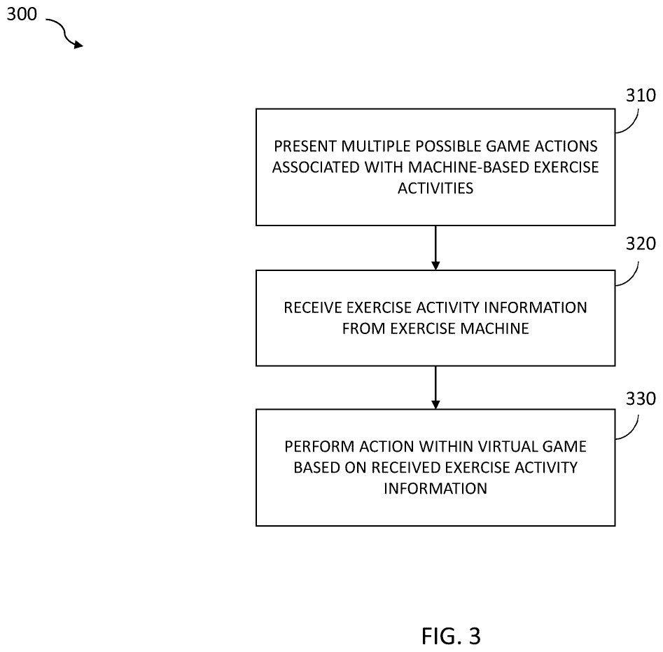

FIG. 3 is a flow diagram illustrating a method 300 for performing a game action within a video game associated with an exercise machine. The method 300 may be performed by the gaming platform 140 and, accordingly, is described herein merely by way of reference thereto. It will be appreciated that the method 300 may be performed on any suitable hardware.

In operation 310, the gaming platform 140 presents multiple possible game actions associated with machine-based activities. The gaming platform 140, via a music-based video game displayed to a player on an exercise bike within a gaming environment, can present different areas within a gaming environment to which the player can navigate their associated or representative avatar.

The gaming platform 140, in operation 320, receives exercise activity information from the exercise machine. The gaming platform 140 can receive information indicating the player has adjusted various controls of the exercise machine, such as resistance controls (e.g., resistance knob) for an exercise bike, incline controls (e.g., rotary controls) for a treadmill, resistance or damping controls (e.g., handle controls) for a rowing machine, and so on.

The gaming platform 140, in operation 330, performs an action within the gaming environment based on the received exercise activity information. For example, the gaming platform 140, in response to the received exercise activity information received from the exercise machine, causes an avatar within the gaming environment to move within the gaming environment, depending on the activity information (e.g., an increase or decrease of settings).

Thus, a machine control can act as a joystick for the video game, functioning both to change the settings (e.g., resistance, incline level) applied to the exercise machine and to control game actions (e.g., movement of an avatar) within a video game.

In addition to resistance controls, other activity controls can function to control both exercise machines and video game actions, as described herein. For example, the increase/decrease of the cadence of an exercise bike can cause game actions to speed up or slow down within a video game (e.g., the movement of coins or other rewards to the avatar). Further, the change in speed or incline of a treadmill and/or the change in speed or damping of a rower can control similar actions for video games associated with these machines.

Similarly, other sensors (e.g., heart rate monitors, pedal sensors and seat sensors for exercise bikes, treadmill belt sensors and user position sensors for treadmills) can provide additional activity information that causes the performance of game actions within the video game. The activity controls, in other cases, can include auxiliary mechanisms, such as buttons, separate joysticks, or other devices that are part of an exercise machine or added to the machine as a separate device.

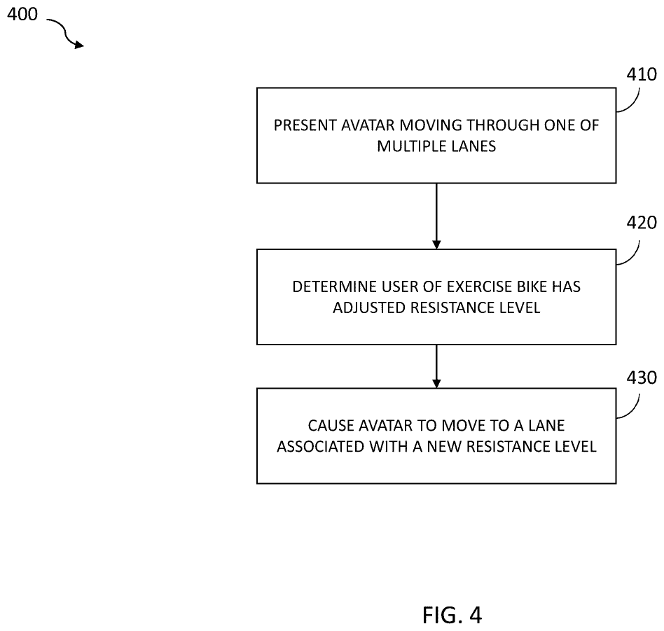

As described herein, the gaming platform can control actions within a video game based on input information received from an associated exercise machine, such as an exercise bicycle. FIG. 4 is a flow diagram illustrating a method 400 for controlling a video game via an exercise bicycle. The method 400 may be performed by the gaming platform 140 and, accordingly, is described herein merely by way of reference thereto. It will be appreciated that the method 400 may be performed on any suitable hardware.

In operation 410, the gaming platform 140 presents an avatar moving through an interactive game via one of multiple lanes displayed within the interactive game. The avatar represents a user performing an exercise activity on the exercise bicycle. Each lane of the multiple lanes is associated with a range of resistance levels input by the user to the exercise bicycle via a resistance knob of the exercise bicycle.

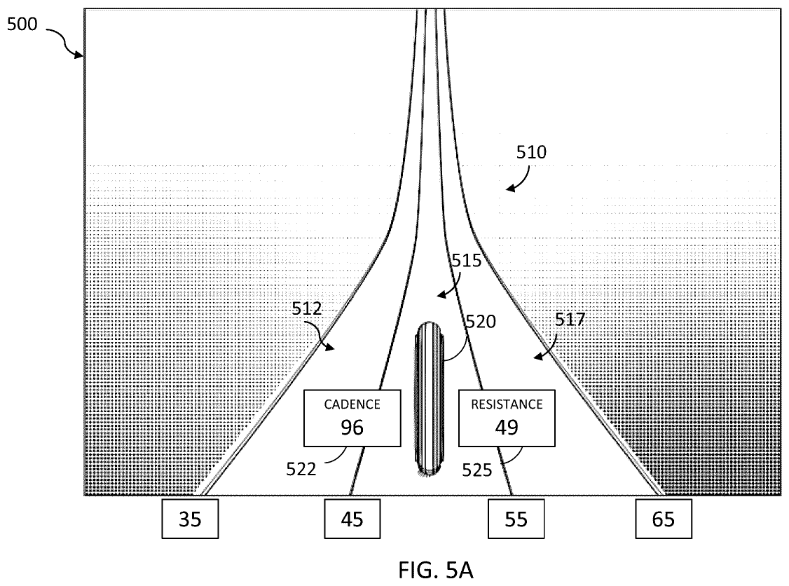

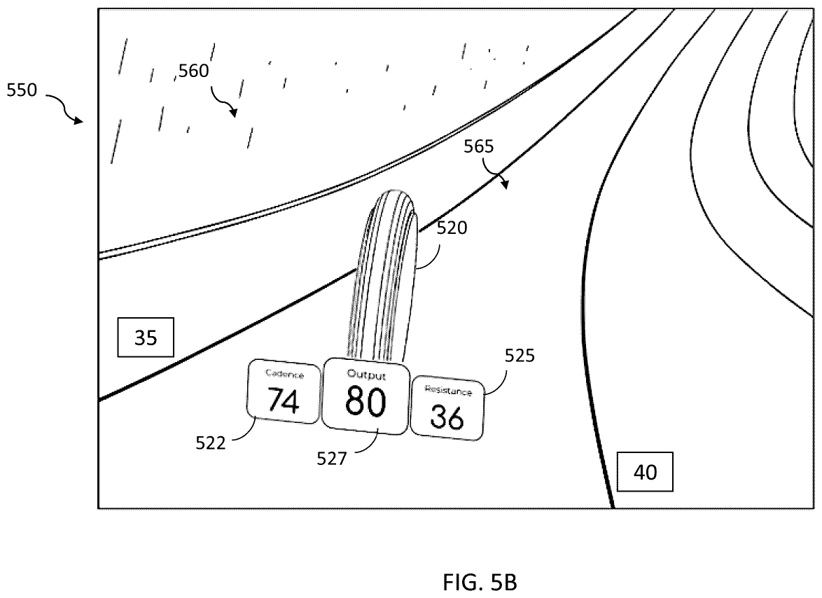

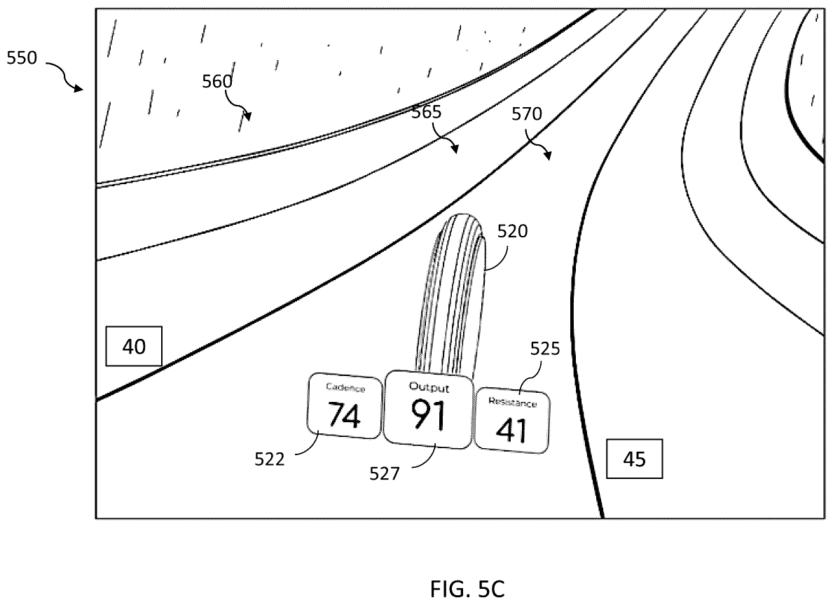

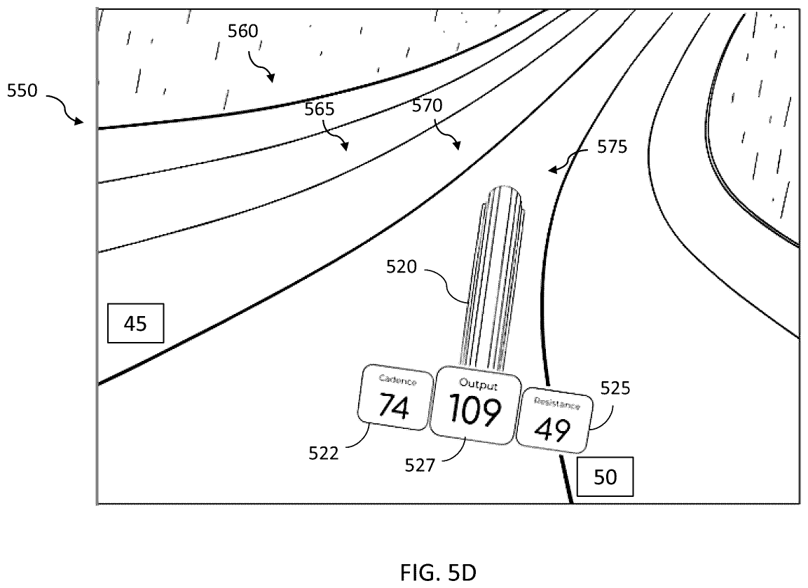

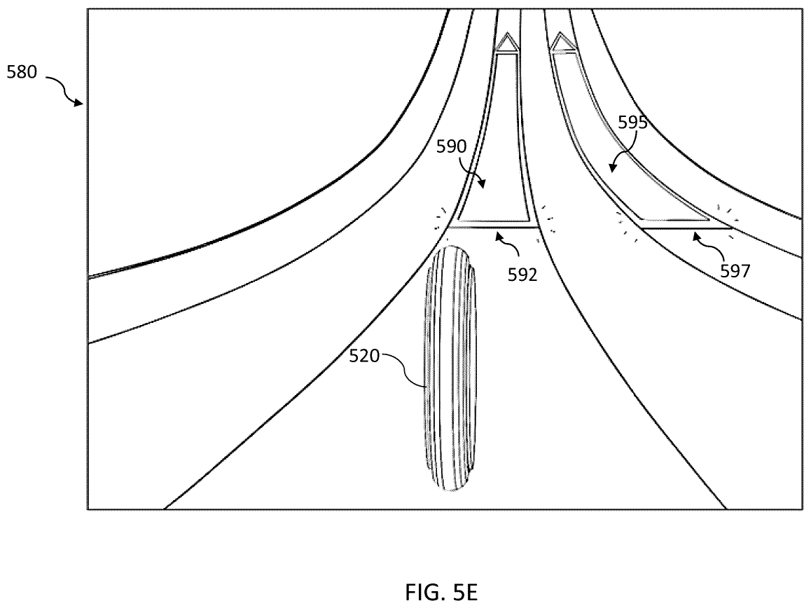

For example, FIG. 5A depicts an interactive game 500 with multiple lanes 510. An avatar 520, representing the user on the exercise bicycle, moves or progresses through the interactive game via one or more of the lanes 510 (or channels, paths, roads, and so on). While FIG. 5A depicts three lanes, any number of lanes (e.g., four, six, and so on) can be part of the game 500. The multiple lanes are each associated with a range of resistance levels (e.g., lane 512 is associated with a range of 35-45, lane 515 is associated with a range of 45-55, and lane 517 is associated with a range of 55-65, where the resistance applied to the bicycle is measured from 0-100).

The game 500 also depicts the current activity levels for the user on the bicycle, such as cadence level 522 (e.g., related to the effort of the user) and resistance level 525 (e.g., related to a current difficulty setting of the bicycle). As depicted, the avatar 520 is moving through the video game via the center lane 515, because the current resistance level 525, which is within the range of 45-55 that is assigned or otherwise associated with the center lane 515.

Referring back to FIG. 4, the gaming platform 140, in operation 420, determines that the user has modified a current resistance level of the exercise bicycle via the resistance knob. For example, the input module 210 can receive input from the exercise bicycle that indicates the user has adjusted their resistance level to a different resistance value or level.

In operation 430, the gaming platform 140 causes the avatar to move through the interactive game via a different lane displayed within the interactive game that includes the modified resistance level within the range of resistance levels associated with the lane. For example, the game control module 220 can cause the avatar that represents the user performing the exercise activity to move within the video game to a lane within the video game that is associated with the modified resistance level.

FIGS. 5B-5D depict such game actions. First, as depicted in FIG. 5B, the avatar 520 travels or progresses via a specific lane 565 of six different lanes 560 within a video game 550 presented to the user of the exercise bicycle (e.g., via the display of the exercise bicycle). The lane 565 is associated with a resistance level range of 35-40. The activity level information indicates the cadence level 522 is 74 and the resistance level 525 is 36 (e.g., giving an output of 80 KJ). Thus, the avatar 520 is located within the lane 565, as the resistance level 525 is within the range of levels for the lane 565.

FIG. 5C depicts movement of the avatar 520 to a different lane 570, because the resistance level 525 has changed (e.g., has increased from a value of 36 to a value of 41). The gaming platform 140, as described herein, causes the video game 550 to perform a game action where the avatar 520 changes lanes (from lane 565 to lane 570) based on the change in the resistance level (e.g., from 36 to 41), since the lane 570 is associated with a range of 40-45 for the resistance level.

The user continues to increase their resistance level at the exercise bicycle (e.g., via the resistance knob), and their avatar 520 moves into a new lane 575, as depicted in FIG. 5D. The gaming platform 140, as described herein, causes the video game 550 to perform a game action where the avatar 520 changes lanes (from lane 570 to lane 575) based on the change in the resistance level (e.g., from 41 to 49), since the lane 575 is associated with a range of 45-50 for the resistance level.

Of course, the lanes can be associated with other activity level values or metrics, such as the output level 527, which is tied to the resistance level applied to the exercise bicycle (e.g., output can be calculated from resistance and cadence). In such cases, the user can cause their avatar 520 to move between lanes 550 based on the generated output level (e.g., in kJ or calories) or other similar metrics.

In some cases, the video game can present multiple lane options for a user, as described herein. For example, as depicted in FIG. 5E, a video game 580 can present the avatar with two different lanes 590, 595 that each include scoring objects 592, 597 or otherwise indicate that the user should control their resistance level to move their avatar 520 into one of the two lanes 590, 595, in order to score points or earn rewards. In some cases, the lanes can provide the user with options of scoring points based on different levels of difficulty, which are tied to the difficulty setting of their exercise machine (e.g., resistance or incline levels). Thus, as depicted, lane 590 may be a lower scoring option, because it causes a user to maintain or lower their difficulty level, whereas lane 595 may be a higher scoring option, because the user, to move to the lane 595, will have to adjust their difficulty setting to a higher difficulty level (e.g., increase the resistance or incline).

Thus, the gaming platform 140, as depicted in FIG. 5E, can cause the interactive game to present a first graphical element (e.g., scoring element 592) that prompts the user performing the exercise activity to move to a first lane (e.g., lane 590) displayed within the interactive game 580 and also present a second graphical element (e.g., scoring element 597) that prompts the user performing the exercise activity to move to a second lane (e.g., lane 595) displayed within the interactive game 580. In some cases, the first lane is associated with a comparatively equal or lower range of resistance levels than a range of resistance levels for a lane within which the avatar representing the user is currently located, and the second lane is associated with a comparatively higher range of resistance levels than the range of resistance levels for the lane within which the avatar representing the user is currently located. The platform 140, as described herein, can determine that the user has modified the current resistance level of the exercise bicycle to a resistance level that is within the lower range of resistance levels or the higher range of resistance levels, and cause the avatar (e.g., avatar 520) representing the user to move through the game via the first lane or the second lane based on the resistance level that is within the lower range of resistance levels or the higher range of resistance levels.

Thus, the gaming platform 140, in various implementations, enables a player, via their exercise bike, to adjust a resistance control (e.g., a knob, tapping the screen and/or via an automatic resistance control) on the exercise bike, which sends the information to the gaming platform 140, to control movement of an associated avatar within the gaming environment. The movement can be discrete (moving between lanes or areas) and/or granular or continuous (e.g., positioned within a lane or area based on the resistance level).

The exercise machine, therefore, can act as a dual-functional or multi-functional joystick that receives multiple game inputs (e.g., resistance changes, cadence changes, speed changes, incline changes, and so on), which in combination control game actions and/or scoring within a video game.

For example, an exercise bicycle can act as a multi-functional joystick by providing game control information from resistance setting levels and changes, cadence levels and changes, and other sensed or measured information. The exercise bike can include seat sensors, handlebar sensors, pedal sensors, crank arm sensors, and so on, which capture information that can inform or control game actions.

For example, the gaming platform 140 can determine from information captured by one or more pedal sensors of the exercise bicycle that the user is performing a gesture while performing the exercise activity via the exercise bicycle. Gestures can include standing on the pedals, leaning to one side of the bicycle, and so on. The platform 140 can cause the avatar associated with the user to perform a game action within the interactive game in response to the gesture performed by the user. For example the avatar can move between lanes, performing certain scoring actions, move ahead of the game, and so on.

In some embodiments, the user's effort level (e.g., associated with pedaling cadence, running speed, rowing speed, and so on) causes their associated avatar to progress through a game at a comparable rate or pace. However, as described herein, the video game, such as a music- or rhythm-based video game, can cause the avatar to progress through the game at a pace that is based on multimedia content presented by the game, such as the tempo of music played within the game.

For example, the gaming platform 140 can cause the avatar to progress through the interactive game at a speed that is associated with a tempo of music played within the interactive game and not associated with a pedal cadence or speed of the user performing the exercise activity via an exercise bicycle or treadmill, respectively. Thus, the game, in such cases, can utilize exercise machine activity information for awarding points and controlling game actions, but does not utilize machine activity information to progress the game.

The following section presents details associated with various game mechanics and/or game actions controlled or responsive to exercise activities performed via exercise machines (such as exercise bicycles), as well as scoring mechanism and scoring/progression mechanics for interactive games controlled, at least in part, by an exercise machine.

### Examples of Game Mechanics Presented by the Gaming Platform

As described herein, the gaming platform, in some embodiments, presents music or music-rhythm games to users of exercise machines performing exercise activities, such as cycling, running, walking, rowing, and so on. These games, or virtual experiences, can be centered or based on music, where players pickup tempo-, beat-, rhythm-, and/or music-synched scoring objects, such as coins, points, or markers along a track or within a game (e.g., within a scoring lane). Further, their actions or exercise activities at their exercise machines can cause increased or enhanced scoring or rewards, such as when they perform with additional effort (e.g., increased cadence or speed) in response to encountering a scoring object or other game presented scoring element or opportunity.

As described herein, the players control associated avatars using resistance/cadence controls on a bike or incline/speed controls on a treadmill. However, the locations and movement of the scoring objects follow the intensity or tempo of the songs played to the players as they progress through the interactive games.

Thus, the video game, in some cases, blends beat and/or rhythm synchronized visuals and gameplay or actions with “levels” designed around different types of fitness or exercise workouts (e.g., HIIT, endurance, recovery, and so on). Players can choose from several different levels, each based on specific playlists and workout types, having varying difficulty ratings (e.g., easy to hard).

As an example, during a game, a player controls an avatar on a track with multiple lanes, which reflect or are associated with different levels of resistance that is applied to the player's bicycle (e.g., lanes can reflect 1-30 resistance values, 31-60 resistance values, 61-100 resistance values), which can be increasingly more difficult to sustain by the player during the activity. In some cases, the resistance values can be set by the platform or are pre-determined.

In other cases, such as via analysis and/or modeling of a player's historical performance information based on previous workouts and goals for a specific workout, the values can be personalized ranges based on a current fitness level, immediate goals, an analysis of a current exercise activity, and so on.

Further, the video game can display various objects (e.g., scoring objects) on the track or lane that are synchronized with the beat of the music and placed strategically in the different lanes based, in part, on the workout goals, the workout type, the difficulty level, the user's experience or capabilities, intensity of the song or songs, and other factors. The video game can challenge players to get a highest score and can include mechanics to redeem points and challenge other players of the video game (in real-time or through asynchronous playing of the game).

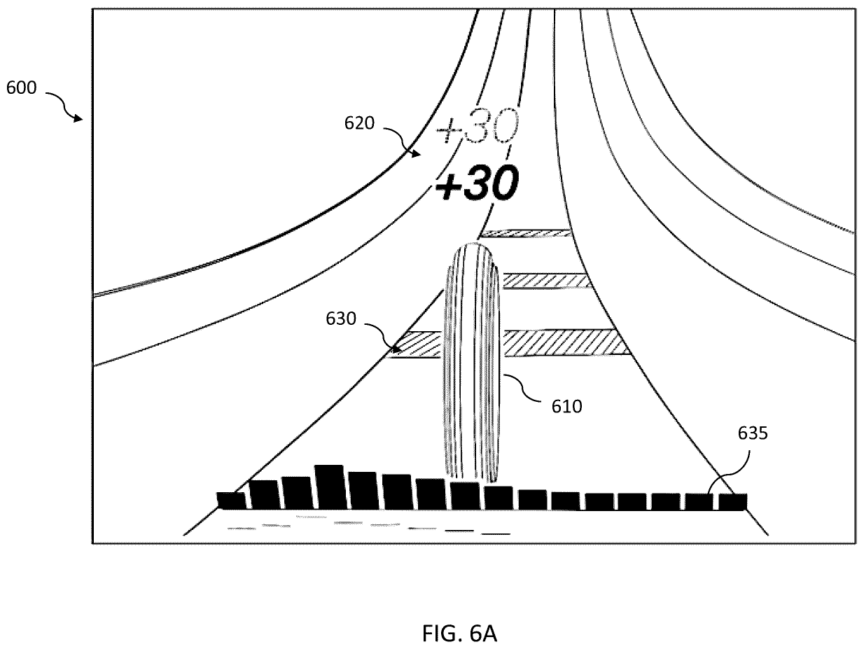

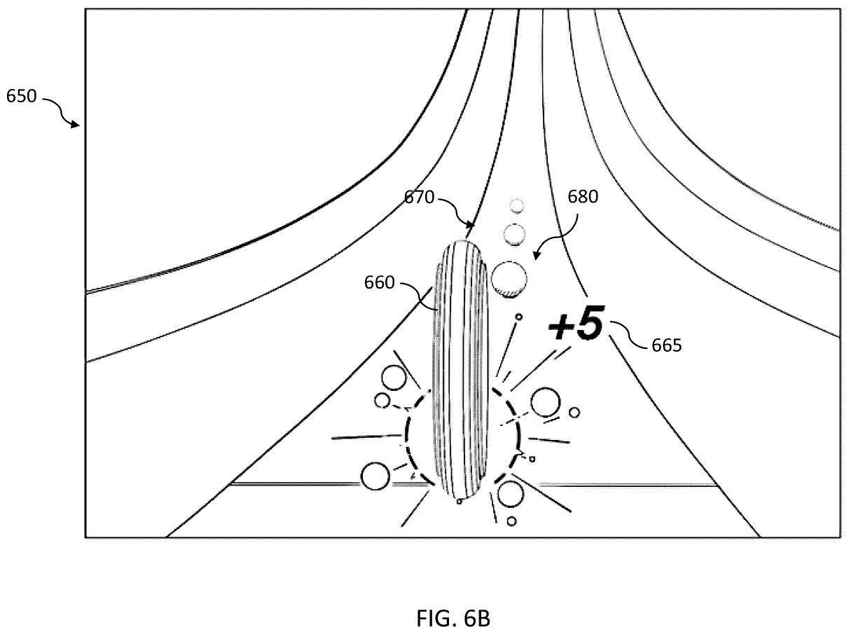

As described herein, the gaming platform 140 can reward the user with points based on actions performed within the game, such as actions of navigating their avatar 520 to certain lanes, increasing their cadence within the lanes, performing certain exercise activities with respect to scoring objects, and so on. In some cases, the gaming platform can present different scoring objects or elements within the game. FIGS. 6A-8B depict different types of scoring objects via which a user can score points based on their activity or performance on an associated exercise machine, such as an exercise bicycle or treadmill.

FIG. 6A depicts a video game 600 presenting a pickup scoring mechanic. For example, an avatar 610 associated with a user riding an exercise bicycle moves or progresses through a specific lane 620 that will reward the user points. The lane includes scoring objects 630, such as lane markers, that award points to the user when they pass the markers (and, in some cases, when the user is pedaling at a certain minimum or threshold cadence). The game 600 can present or display the scoring objects, or markers, at different intervals or spacings, such as at intervals that align with the rhythm, tempo, melody, or harmony of a playing song (e.g., which can be depicted via a graphical element 635).

FIG. 6B depicts a video game 650 having a similar pickup scoring mechanic. In the game 650, scoring objects 680, such as “coins” or “joules,” are collected by the player if/when the player's avatar 660 progress into a scoring lane 670. In some cases, the scoring objects appear at regular intervals on the track or lane 670, matching the beat and tempo of a playing song. In some cases, the scoring objects 680 in higher resistance lanes can have a higher point value than other scoring objects.

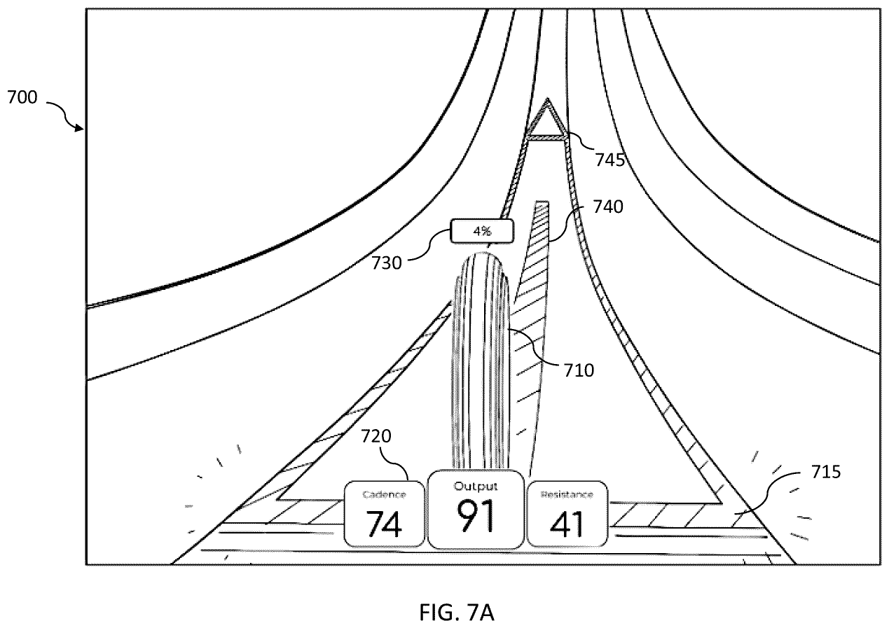

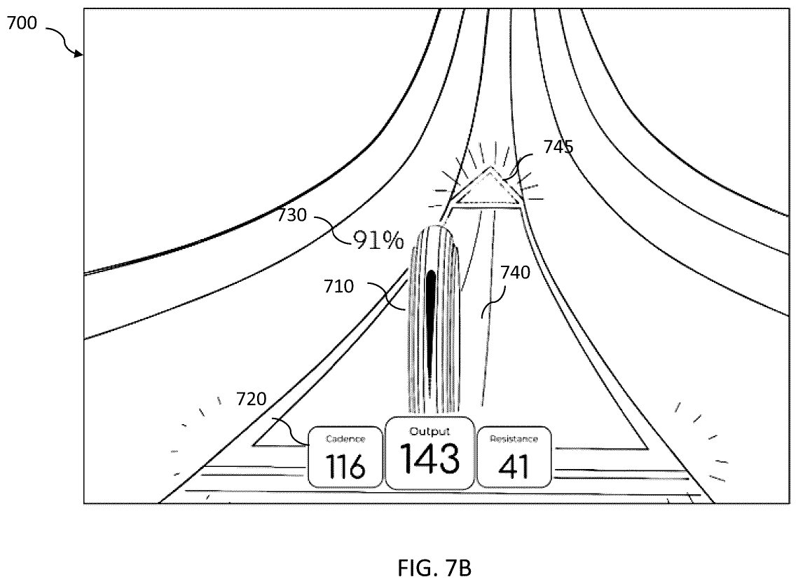

FIGS. 7A-7B illustrate an example breaker game mechanic provided by a video game 700 associated with an exercise machine. The breaker game mechanic presents scoring objects that cause a player to pass specific output thresholds (or cadence or other effort thresholds) over a specified period of time (e.g., two measures of a song to build up energy). For example, the avatar 710 representing the player initially passes a breaker gate 715 to start a transfer of energy or charging to a breaker scoring object 745.

The player then charges a first breaker based on their cadence or speed 720. For example, the player causes a charging progression 730 of 4% (in FIG. 7A) to 91% (in FIG. 7B) as the player's cadence increases from 91 to 116, where the faster they pedal the faster the breaker charges. Next, the player reaches the breaker 745, targeted by an increasing path of light 740, which explodes and awards the player points based on their charging actions.

In some cases, the game 700 can present pass through charging actions, where the player can charge breakers in sequence based on their cadence (or speed) and overcharge the breaker 745 (go above 100% charged) to earn additional points or rewards. Thus, the breaker scoring object 745 is controlled and modified based on the effort, cadence, speed, or output provide by the player on their exercise machine, while the progress of the avatar 710 is based on or set to the tempo of the game 700.

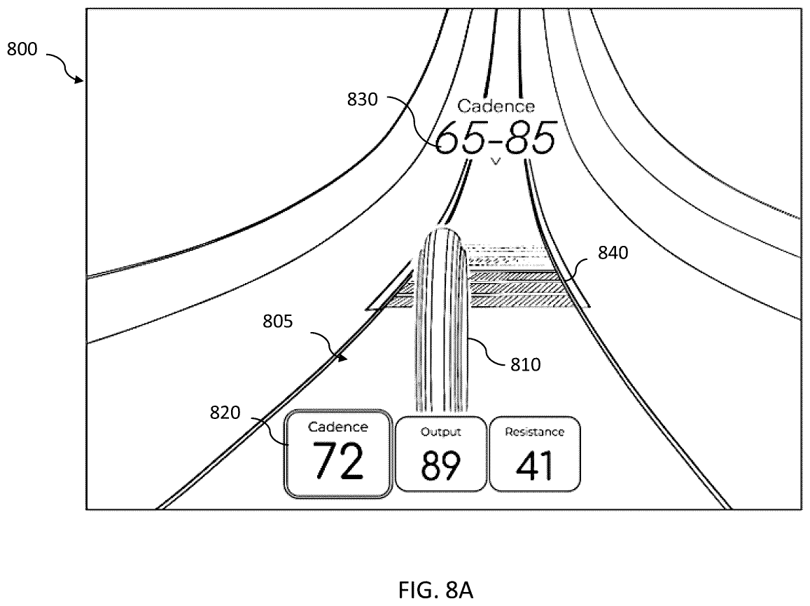

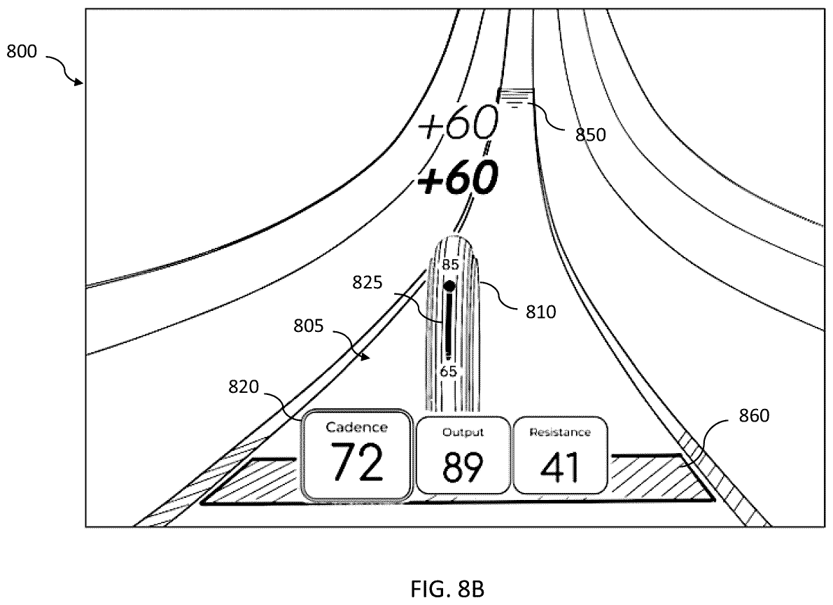

FIGS. 8A-8B illustrate an example stream game mechanic provided by a video game 800 associated with an exercise machine. The stream mechanic, in some cases, awards points to players as they maintain a certain or threshold effort (e.g., cadence, speed, output, and so on) for a certain time period or within a certain scoring area (e.g., a lane, span, track, path) of the video game 800.

The stream game mechanic can present visible spans that appear in one or more lanes. Inside the span, players collect points for every second/beat they perform within a presented cadence/speed range. When the player is not matching the cadence range, they do not collect points. In some cases, the spans can begin and end on a beat.

In some cases, a game progression can present a first, easy span (10 seconds at low RPM), a middle span (20 seconds at medium RPM), and a hard span (30 seconds at high RPM or full effort). The progression can also display information about the span, such as information indicating whether the player is in or out of a requested range for a span.

For example, an avatar 810 associated with the player approaches a scoring span within a lane 805 at a certain cadence 820. The span provides information 830 about the range of effort that rewards points to the player, and a starting point 840 or line that indicates when the player can begin earning points in the span.

As the player progresses in the span, the cadence 825 is shown (e.g., in some cases as a graphic within the avatar) and when the avatar 810 reaches certain scoring markers 860 (e.g., presented on each beat of a playing music tempo) they are rewarded points. The player continues to earn points when they maintain a cadence that exceeds or is within the range of cadence levels associated with earning points until they reach an endpoint 850 of the span.

As described herein, the gaming platform 140, in some embodiments, provides options or choices to players as they progress in a video game, such as options to choose one of multiple different lanes to move into and score points or earn rewards. Thus, the video game can award different amounts of points (e.g., applying multipliers) based on the effort or difficulty of the lane. For example, a first lane can reward users with a base number of points as the player moves through the lane at a certain cadence and resistance, and a second lane can reward users with a multiplied (e.g., 1.2× or 1.4×) number of points as the player moves through the lane at a comparatively higher cadence and resistance.

Of course, a video game, via the gaming platform 140, can reward players with points or rewards based on various combinations of the scoring game mechanics described herein. Thus, in some cases, the following game actions can cause the use to score points or otherwise be rewarded within the video game:
The gaming platform 140 can cause the interactive game to present a graphical element that prompts the user performing the exercise activity to move to a specific or different lane, and after determining that the user has modified the current resistance level of the exercise bicycle via the resistance knob to a resistance level within the within the range of resistance levels associated with the different lane, reward the user with points while the avatar representing the user is within the different lane;
The gaming platform 140 can cause the user to earn points (e.g., reward the user) when the user pedals at a threshold cadence level while performing the exercise activity on the exercise bicycle and while the avatar 520 representing the user moves through the interactive game via the different lane displayed within the interactive game that includes the modified resistance level within the range of resistance levels associated with the lane;
The gaming platform 140 can cause the user to earn points (e.g., reward the user) when the user pedals at an increased cadence level while performing the exercise activity on the exercise bicycle and while the avatar 520 representing the user moves through the game via the different lane displayed within the interactive game and encounters a cadence-based scoring object within the different lane;
The gaming platform 140 can cause the user to earn points when the user pedals at a maintained cadence level while performing the exercise activity on the exercise bicycle and while the avatar representing the user moves through the interactive game via the different lane from a beginning position within the different lane to an ending position within the different lane; and so on.

In some embodiments, the gaming platform 140 alerts or warns players when their efforts/settings fall below certain minimum scoring thresholds and/or when they are exercising at extreme ends of the capabilities of the exercise machine.

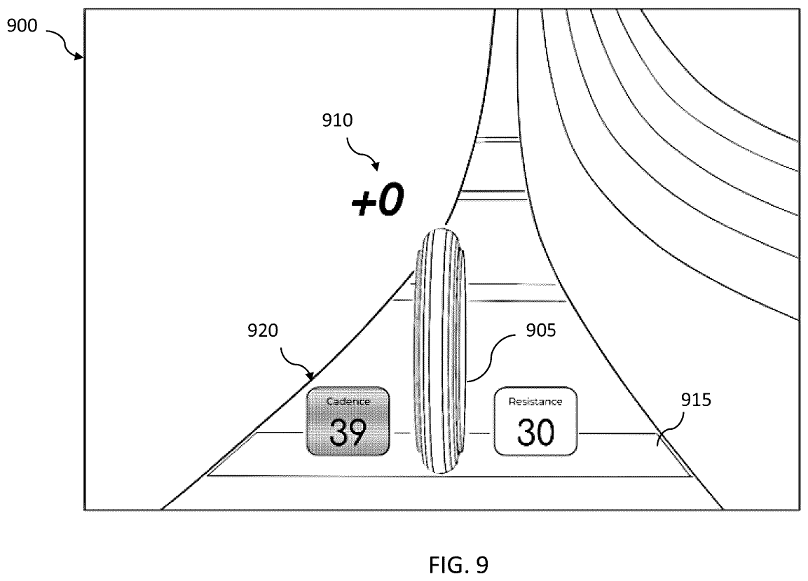

FIG. 9 illustrates an example cadence game mechanic provided by a video game 900 associated with an exercise machine. In some cases, the video game 900 can assign a minimum cadence value (or speed value) to a difficulty level, to avoid players earning points without pedaling or running (or doing so with little effort). Thus, the game can impose minimum exercise or activity thresholds that are to be met by players to earn points or rewards within a game. As depicted, the player earns 0 points 910 when picking up or passing a scoring object 915, because their cadence 920 is below a threshold cadence value (e.g., their 39 cadence<40 threshold cadence) for the lane, level, or game.

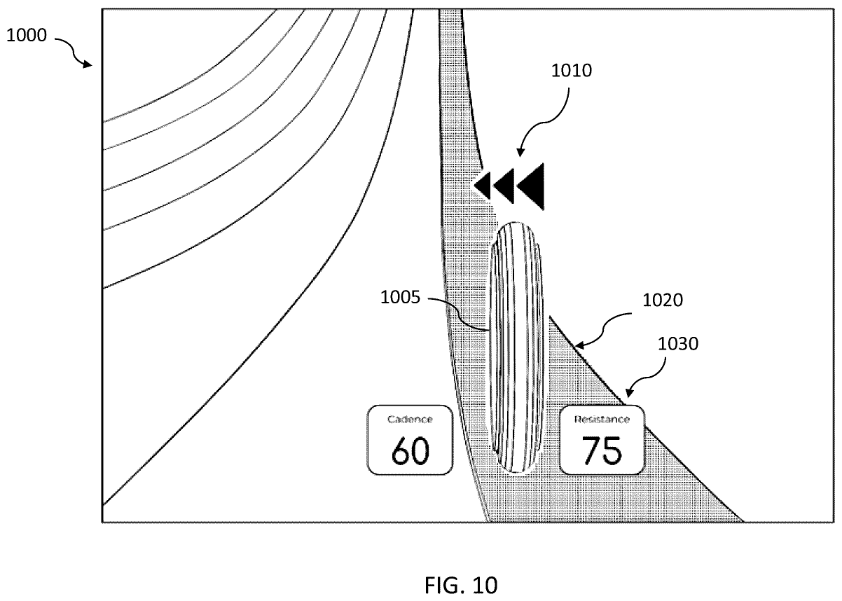

As another example, FIG. 10 depicts an example player guidance game mechanic provided by a video game 1000 associated with an exercise machine. Because an exercise machine can facilitate the application of very high (e.g., 80-100) or very low (e.g., 0-20) resistance levels, the game 1000 can present graphics that guide the player away from the extreme resistance values. For example, the game 1000 can present a guidance element 1010 and/or gutter 1020 or boundary element that guides the player (e.g., an avatar 1005) away from the edge of a lane or track, and away from very high resistance values 1030, such as 75% or 80% or higher.

In some cases, a video game can utilize guidance elements to inform the player of upcoming actions (lane changes), as well as instructing the player to modify their effort or difficulty in order to earn points or rewards. Further, in some embodiments, the gaming platform 140 can function to allows users to specify or personalize a video or interactive game for users or players. For example, the game can receive input from players to select a number of lanes, resistance levels applied to the lanes, the types of scoring elements, and so on.

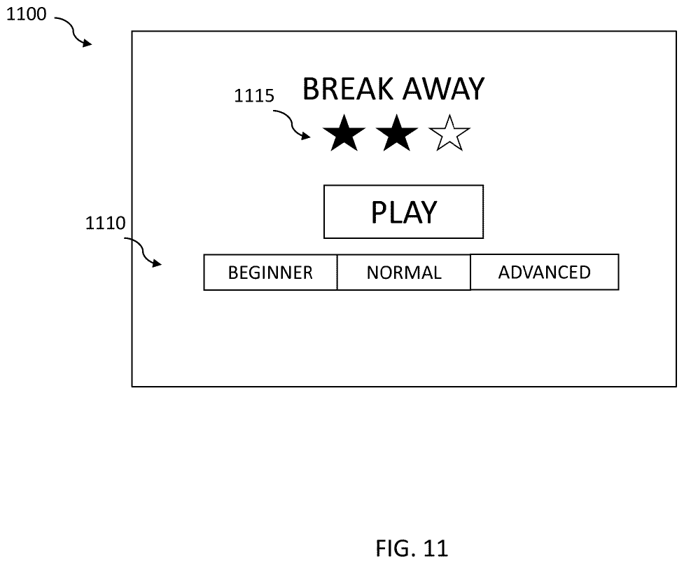

FIG. 11 is a diagram illustrating an example user interface 1100 that facilitates the selection of a difficulty level 1100 for a video game (e.g., “BREAK AWAY”) associated with an exercise machine. As depicted, the user interface 1100 can present user-selectable options 1110 for difficulty levels for a video game or level of a game, as well as ratings information 1115 for the video game (e.g., crowd-sourced ratings information).

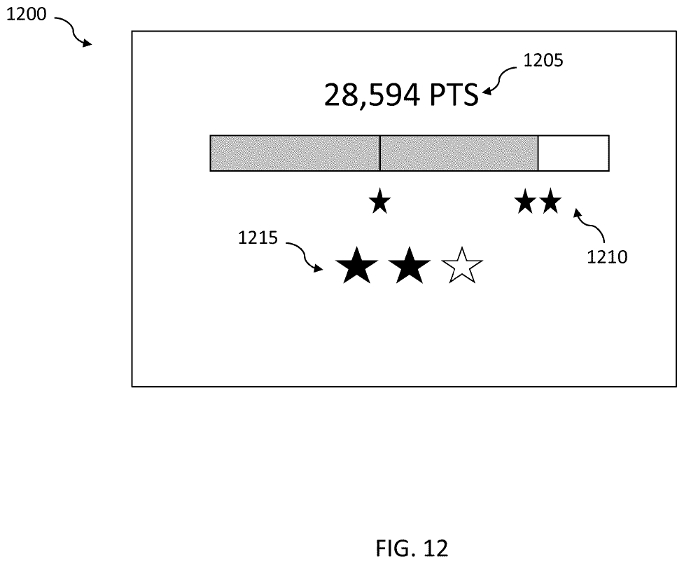

FIG. 12 is a diagram illustrating an example user interface 1200 that presents game accomplishment information for a video game associated with an exercise machine. For example, the user interface 1200 can present the points 1210 won by a player during a game or level, as well as the number of stars 1215 or 1220 earned by the player during the game or level. In some cases, information about the stars earned can be granular (see display element 1210) and display the stars earned as well as the achievement gap between stars that the player has or has not earned.

In some cases, the gaming platform 140 can provide different scoring mechanisms for progressions or achievements within video games. As depicted, the scoring mechanism seeks to balance difficulty and challenges for a workout or exercise activity. The scoring mechanism, instead of defining hard numbers for each challenge in different situations, can utilize a scale to systemize the score of each challenge in different situations to be context-coupled and/or mathematically connected. Via this abstract model, the mechanism can clarify the meaning of each score-related element and the relationships between elements. The following is an example scoring mechanism for calculating points by challenge over time:

Score=(Challenge Scale*Location Scale*Difficulty Scale)*Point Unit*Beats. Of course, the platform 140 can utilize other scoring mechanisms.

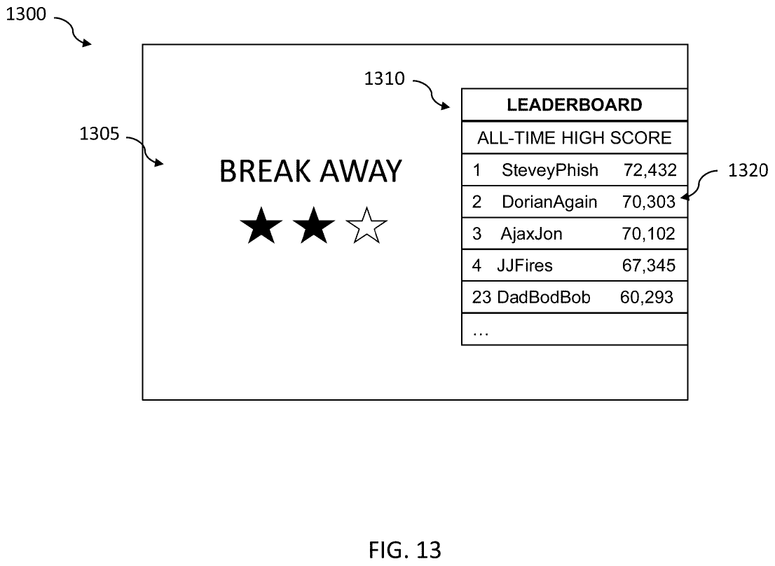

FIG. 13 is a diagram illustrating an example user interface 1300 that presents a leaderboard 1310 for a video game 1305 with an exercise machine. A video game can present the leaderboard 1310 before, during, or after the playing of a game or level, giving players information to share and compare with other players 1320 of the game or level. The leaderboard 1310 can include information associated with the number of points earned (e.g., points earned all time and/or within a certain time period (e.g., daily or weekly), the difficulty of the video game, the music or tracks played during the game, the progression (e.g., the combination of lanes) through the video game, and so on.

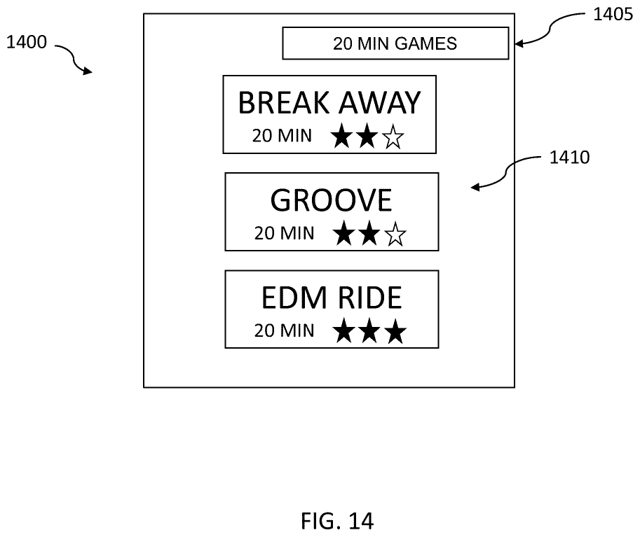

Further, FIG. 14 is a diagram illustrating an example user interface 1400 that presents user-selectable games 1410 to be played with an exercise machine. The gaming platform 140 can provide players with various selectable games 1410, such as when the user selects a filter 1405 to present games having certain parameters or characteristics. The games can also be automatically filtered, and be displayed specific to the exercise machine, specific to the player, and so on.

### Examples of Enhancing Game Mechanics

As described herein, the gaming platform 140 provides users of exercise machines with rich, immersive game play that is tied to and controlled by their actions during an exercise activity, such as actions associated with speeding up or slowing down, changing effort levels, and so on.

In some embodiments, the gaming platform 140 can provide a multiplayer game, where the gaming environment presents multiple different players via avatars as they navigate a game or otherwise play within a gaming environment in real-time. Thus, one player, as they move between lanes, can see avatars of other players navigating the lanes, as well as a real-time leaderboard that constantly or periodically updates scores for the players.

Further, the game can also present ghost avatars of previously played users (e.g., users during playback of an archived game). In some cases, the game can present the progression (e.g., the combination of lanes or a path traveled by a user) to a new user, challenging the new user to follow the path created by one or more of the previous players. This progression, path, or sequence performed by a user can be a “ghost path” or other representation of a previous user's journey through the game. The ghost paths can be rated, and new users can select a path to follow based on their ratings (e.g., easy, medium, difficult, high cadence, high resistance, high speed, and so on). The game can then score the new user based on how close they follow a ghost path and/or whether they exceed or improve upon the path, among other challenge factors or metrics.

Thus, the platform 140, in some embodiments, can generate or capture a progression or path for a first user as they play or perform within a video game, receive input from a second, later user to play the same or similar game, and present the game to the second user based on the captured progression or path of the first user.

In some embodiments, the gaming platform 140 can procedurally or automatically generate levels or game mechanics in response to the music or beats selected for the level. For example, the platform 140 can receive a playlist of one or more songs and generate levels that include lanes/tracks/objects presented in a manner that tracks to the songs of the playlist.

These procedurally generated levels can also be based on the player, where the track or gaming environment is rendered based on the music played during the game, and objects within the game are rendered and presented based on characteristics of the player. For example, a beginning player can play with objects presented at a slower or easier to obtain frequency or speed, while an advanced player may see objects that are harder to obtain within the game.

The platform 140, therefore, can build games following a modular blueprint or mechanism, where the levels/tracks/environment are selected based on the music or playlist selected for the game, and the objects or game actions are selected based on the player, the player's experience, or the player's requested or desired difficulty level.

Thus, the player can input workout parameters and music genre, and the platform 140 can generate a mix of music and dynamically generate a level or levels that presents a game based on the player's desired workout and requested music. For example, the platform 140 can generate a midi file (or other data file) for the level, and auto-stitch the music to the file to create the custom level for the player.

As described herein, the gaming platform 140, in some cases, utilizes the controls (e.g., resistance knob, incline control) of the exercise machine 110 as joystick controls for a video game. Thus, the gaming platform 140 can present games where the player controls the game play using such controls. For example, the player can play a game of “pong” or “tower defense” by controlling the paddles within the game via the resistance knob (and while pedaling at a certain cadence).

The exercise machine 110, then, can act as a multi-input controller for the game, where the controller is constantly and/or consistently providing an ever-changing effort or activity level to the gaming platform 140, which performs game actions in response to the effort or activity level.

### Example Embodiments of the Disclosed Technology

The following are example embodiments of the technology described herein.

In some embodiments, a system for controlling actions within a video game environment includes an input module that interfaces with an exercise machine upon which a user is performing an exercise activity, wherein the input module receives input from the exercise machine, including input information that represents an effort of the user while the user is performing the exercise activity and input information that indicates a current setting of the exercise machine while the user is performing the exercise activity. Further, the system includes a game control module that communicates with the input module and controls a video game running within the video game environment that is presented to the user performing the exercise activity via a display of the exercise machine, by causing an avatar that represents the user performing the exercise activity to move within the video game to a location within the video game that is associated with the current setting of the exercise machine and causing the user performing the exercise activity to score points within the video game when the information that represents the effort of the user satisfies a threshold associated with points rewards within the video game running within the video game environment.

In some embodiments, the exercise machine is an exercise bicycle and the current setting of the exercise bicycle is a resistance setting set by the user of the exercise bicycle by turning a resistance knob of the exercise bicycle, and where the game control module causes the avatar that represents the user performing the exercise activity to move from a first location within the video game to a second location within the video game when the input module receives information that the user has turned the resistance knob to increase the resistance setting of the exercise bicycle.

In some embodiments, the exercise machine is an exercise bicycle, and the current setting of the exercise bicycle is a resistance setting set by the user of the exercise bicycle by turning a resistance knob of the exercise bicycle.

In some embodiments, the exercise machine is an exercise bicycle, and the input information that represents an effort of the user while the user is performing the exercise activity includes information that identifies a cadence associated with pedal strokes performed by the user via the exercise bicycle.

In some embodiments, the exercise machine is a treadmill, and the current setting of the treadmill is an incline level setting set by the user of the treadmill by turning a rotary control of the treadmill, wherein the game control module causes the avatar that represents the user performing the exercise activity to move from a first location within the video game to a second location within the video game when the input module receives information that the user has turned the rotary control to increase the incline level setting of the treadmill.

In some embodiments, the exercise machine is a treadmill, and the current setting of the treadmill is an incline level setting set by the user of the treadmill by turning a rotary control of the treadmill.

In some embodiments, the exercise machine is a treadmill, and the input information that represents an effort of the user while the user is performing the exercise activity includes information that identifies a belt speed of the treadmill.

In some embodiments, the video game running within the video game environment causes the avatar that represents the user performing the exercise activity to progress through the video game at a speed that matches a tempo of music being played within the video game.

In some embodiments, the video game running within the video game environment causes the avatar that represents the user performing the exercise activity to encounter scoring objects within the video game at a speed that matches a tempo of music being played within the video game.

In some embodiments, the game control module causes the user performing the exercise activity to score points within the video game when the information that represents the effort of the user indicates the user has increased an effort of performing the exercise activity for a certain period of time.

In some embodiments, the game control module causes the user performing the exercise activity to score points within the video game when the information that represents the effort of the user indicates the user has maintained a threshold effort of performing the exercise activity for a certain period of time.

In some embodiments, a method of controlling an interactive game presented by a display of an exercise bicycle includes presenting an avatar moving through the interactive game via one of multiple lanes displayed within the interactive game, where the avatar represents a user performing an exercise activity on the exercise bicycle and where each of the multiple lanes is associated with a range of resistance levels input by the user to the exercise bicycle via a resistance knob of the exercise bicycle. The method determines that the user has modified a current resistance level of the exercise bicycle via the resistance knob and causes the avatar to move through the interactive game via a different lane displayed within the interactive game that includes the modified resistance level within the range of resistance levels associated with the lane.

In some embodiments, the method causes the interactive game to present a graphical element that prompts the user performing the exercise activity to move to the different lane, and after determining that the user has modified the current resistance level of the exercise bicycle via the resistance knob to a resistance level within the within the range of resistance levels associated with the different lane, rewards the user with points while the avatar representing the user is within the different lane.

In some embodiments, the method causes the interactive game to present a first graphical element that prompts the user performing the exercise activity to move to a first lane displayed within the interactive game and present a second graphical element that prompts the user performing the exercise activity to move to a second lane displayed within the interactive game, where the first lane is associated with a comparatively lower range of resistance levels than a range of resistance levels for a lane within which the avatar representing the user is currently located and where the second lane is associated with a comparatively higher range of resistance levels than the range of resistance levels for the lane within which the avatar representing the user is currently located. Further, the method determines that the user has modified the current resistance level of the exercise bicycle to a resistance level that is within the lower range of resistance levels or the higher range of resistance levels and causes the avatar representing the user to move through the game via the first lane or the second lane based on the resistance level that is within the lower range of resistance levels or the higher range of resistance levels.

In some embodiments, the method causes the user to earn points when the user pedals at a threshold cadence level while performing the exercise activity on the exercise bicycle and while the avatar representing the user moves through the interactive game via the different lane displayed within the interactive game that includes the modified resistance level within the range of resistance levels associated with the lane.

In some embodiments, the method causes the user to earn points when the user pedals at an increased cadence level while performing the exercise activity on the exercise bicycle and while the avatar representing the user moves through the interactive game via the different lane displayed within the interactive game and encounters a cadence-based scoring object within the different lane.

In some embodiments, the method causes the user to earn points when the user pedals at a maintained cadence level while performing the exercise activity on the exercise bicycle and while the avatar representing the user moves through the interactive game via the different lane from a beginning position within the different lane to an ending position within the different lane.

In some embodiments, the method causes the avatar to progress through the interactive game at a speed that is associated with a tempo of music played within the interactive game and not associated with a pedal cadence of the user performing the exercise activity via the exercise bicycle.

In some embodiments, the method determines from one or more pedal sensors of the exercise bicycle that the user is performing a gesture while performing the exercise activity via the exercise bicycle and causes the avatar to perform a game action within the interactive game in response to the gesture performed by the user.

In some embodiments, a gaming platform receives an indication that a user of an exercise machine has adjusted a difficulty setting of the exercise machine and causes an avatar associated with the user that is within an interactive game displayed to the user via a display of the exercise machine to move within the interactive game based on the adjustment of the difficulty setting of the exercise machine.

In some embodiments, the gaming platform causes the avatar to move within the interactive game when the user adjusts a resistance setting of an exercise bicycle via a resistance knob of the exercise bicycle.

In some embodiments, the gaming platform causes the avatar to move within the interactive game when the user adjusts an incline level of a treadmill via a rotary control of the treadmill.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or”, in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the technology may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

From the foregoing, it will be appreciated that specific embodiments have been described herein for purposes of illustration, but that various modifications may be made without deviating from the spirit and scope of the embodiments. Accordingly, the embodiments are not limited except as by the appended claims.

1. A system for controlling actions within a video game environment, the system comprising:
an input module that interfaces with an exercise machine upon which a user is performing an exercise activity, wherein the input module receives input from the exercise machine, including:
input information that represents an effort of the user while the user is performing the exercise activity, and
input information that indicates a current setting of the exercise machine while the user is performing the exercise activity; and
a game control module that communicates with the input module and controls a video game running within the video game environment that is presented to the user performing the exercise activity via a display of the exercise machine, by:
causing an avatar that represents the user performing the exercise activity to move within the video game to a location within the video game that is associated with the current setting of the exercise machine; and
causing the user performing the exercise activity to score points within the video game when the information that represents the effort of the user satisfies a threshold associated with points rewards within the video game running within the video game environment.

2. The system of claim 1, wherein the exercise machine is an exercise bicycle and the current setting of the exercise bicycle is a resistance setting set by the user of the exercise bicycle by turning a resistance knob of the exercise bicycle; and
wherein the game control module causes the avatar that represents the user performing the exercise activity to move from a first location within the video game to a second location within the video game when the input module receives information that the user has turned the resistance knob to increase the resistance setting of the exercise bicycle.

3. The system of claim 1, wherein the exercise machine is an exercise bicycle, and wherein the current setting of the exercise bicycle is a resistance setting set by the user of the exercise bicycle by turning a resistance knob of the exercise bicycle.

4. The system of claim 1, wherein the exercise machine is an exercise bicycle, and wherein the input information that represents an effort of the user while the user is performing the exercise activity includes information that identifies a cadence associated with pedal strokes performed by the user via the exercise bicycle.

5. The system of claim 1, wherein the exercise machine is a treadmill and the current setting of the treadmill is an incline level setting set by the user of the treadmill by turning a rotary control of the treadmill; and
wherein the game control module causes the avatar that represents the user performing the exercise activity to move from a first location within the video game to a second location within the video game when the input module receives information that the user has turned the rotary control to increase the incline level setting of the treadmill.

6. The system of claim 1, wherein the exercise machine is a treadmill, and wherein the current setting of the treadmill is an incline level setting set by the user of the treadmill by turning a rotary control of the treadmill.

7. The system of claim 1, wherein the exercise machine is a treadmill, and wherein the input information that represents an effort of the user while the user is performing the exercise activity includes information that identifies a belt speed of the treadmill.

8. The system of claim 1, wherein the video game running within the video game environment causes the avatar that represents the user performing the exercise activity to progress through the video game at a speed that matches a tempo of music being played within the video game.

9. The system of claim 1, wherein the video game running within the video game environment causes the avatar that represents the user performing the exercise activity to encounter scoring objects within the video game at a speed that matches a tempo of music being played within the video game.

10. The system of claim 1, wherein the game control module causes the user performing the exercise activity to score points within the video game when the information that represents the effort of the user indicates the user has increased an effort of performing the exercise activity for a certain period of time.

11. The system of claim 1, wherein the game control module causes the user performing the exercise activity to score points within the video game when the information that represents the effort of the user indicates the user has maintained a threshold effort of performing the exercise activity for a certain period of time.

12. A method of controlling an interactive game presented by a display of an exercise bicycle, the method comprising:
presenting an avatar moving through the interactive game via one of multiple lanes displayed within the interactive game,
wherein the avatar represents a user performing an exercise activity on the exercise bicycle, and
wherein each of the multiple lanes is associated with a range of resistance levels input by the user to the exercise bicycle via a resistance knob of the exercise bicycle;
determining that the user has modified a current resistance level of the exercise bicycle via the resistance knob; and
causing the avatar to move through the interactive game via a different lane displayed within the interactive game that includes the modified resistance level within the range of resistance levels associated with the lane.

13. The method of claim 12, further comprising:
causing the interactive game to present a graphical element that prompts the user performing the exercise activity to move to the different lane; and
after determining that the user has modified the current resistance level of the exercise bicycle via the resistance knob to a resistance level within the within the range of resistance levels associated with the different lane, rewarding the user with points while the avatar representing the user is within the different lane.

14. The method of claim 12, further comprising:
causing the interactive game to present a first graphical element that prompts the user performing the exercise activity to move to a first lane displayed within the interactive game and present a second graphical element that prompts the user performing the exercise activity to move to a second lane displayed within the interactive game,
wherein the first lane is associated with a comparatively lower range of resistance levels than a range of resistance levels for a lane within which the avatar representing the user is currently located, and
wherein the second lane is associated with a comparatively higher range of resistance levels than the range of resistance levels for the lane within which the avatar representing the user is currently located;
determining that the user has modified the current resistance level of the exercise bicycle to a resistance level that is within the lower range of resistance levels or the higher range of resistance levels; and
causing the avatar representing the user to move through the game via the first lane or the second lane based on the resistance level that is within the lower range of resistance levels or the higher range of resistance levels.

15. The method of claim 12, further comprising:
causing the user to earn points when the user pedals at a threshold cadence level while performing the exercise activity on the exercise bicycle and while the avatar representing the user moves through the interactive game via the different lane displayed within the interactive game that includes the modified resistance level within the range of resistance levels associated with the lane.

16. The method of claim 12, further comprising:
causing the user to earn points when the user pedals at an increased cadence level while performing the exercise activity on the exercise bicycle and while the avatar representing the user moves through the interactive game via the different lane displayed within the interactive game and encounters a cadence-based scoring object within the different lane.

17. The method of claim 12, further comprising:
causing the user to earn points when the user pedals at a maintained cadence level while performing the exercise activity on the exercise bicycle and while the avatar representing the user moves through the interactive game via the different lane from a beginning position within the different lane to an ending position within the different lane.

18. The method of claim 12, further comprising:
causing the avatar to progress through the interactive game at a speed that is associated with a tempo of music played within the interactive game and not associated with a pedal cadence of the user performing the exercise activity via the exercise bicycle.

19. The method of claim 12, further comprising:
determining from one or more pedal sensors of the exercise bicycle that the user is performing a gesture while performing the exercise activity via the exercise bicycle; and
causing the avatar to perform a game action within the interactive game in response to the gesture performed by the user.

20. A non-transitory computer-readable medium whose contents, when executed by a gaming platform associated with an exercise machine, cause the gaming platform to perform a method, the method comprising:
receiving an indication that a user of an exercise machine has adjusted a difficulty setting of the exercise machine, and
causing an avatar associated with the user that is within an interactive game displayed to the user via a display of the exercise machine to move within the interactive game based on the adjustment of the difficulty setting of the exercise machine.

21.-22. (canceled)
